(19) United States
(12) Patent Application Publication
(10) Pub. No.: US 2010/0107133 A1
(43) Pub. Date: Apr. 29, 2010

(54) Method for increasing cell uniformity in an integrated circuit by adjusting cell inputs to design process

(76) Inventors: O. Samuel Nakagawa, Redwood City, CA (US); Shao-Po Wu, Valley, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 12/288,793

(22) Filed: Oct. 23, 2008

(51) Int. Cl. G06F 17/50

(52) U.S. Cl. 716/5

(57) ABSTRACT

A method of making instances of a reference cell more uniform across an integrated circuit (IC) by providing a nominal cell for the reference cell and modifying an initial IC layout description to create input into an Optical Proximity Correction (OPC) engine, so as to make the cell instances more like the nominal cell during an IC layout process.

### BACKGROUND

In the design layout of integrated circuits (ICs) a library of reference cell descriptions is maintained in a computer database, each cell description including a circuit layout for a cell typically having from 2 to 50 transistor gates. The circuit designer places these cells and plans out connective lines. A particular reference cell may be used in many different locations in an IC layout, each such location being referred to as an “instance” of the reference cell.

After the circuit designers complete a circuit layout, the design is sent to a fabrication facility where mask data preparation engineers run an optical proximity correction (OPC) engine, which computes a mask layout that is aimed at producing the circuit layout that has been designed. Unfortunately, due to resource constraints the OPC engine will typically not design the masking system so that all instances of a particular cell will be uniform when fabricated in silicon.

Moreover, even if the OPC created a mask that would theoretically produce exactly uniform instances of a cell, variations in the manufacturing process and instance contexts would create non-uniformities between the electrical performance characteristics of one cell instance and another. These non-uniformities greatly complicate the task of computing actual cell performance for parameters such as timing, thereby necessitating the use of wider performance guard bands to ensure that all the circuit elements can properly work together. But the use of wider timing guard bands, for example, reduces potential circuit performance as it means that some circuit elements will have their timing slowed down to avoid a timing glitch, due to the difficulty in determining what timing relationships are required between cells.

Moreover, the OPC engine is executed on the circuit layout as a whole and there is no check on the fidelity of any particular post-OPC cell to the library cell upon which it is based. There is also typically no effort to understand how variations introduced by OPC and/or fabrication affects performance on the cell electrical level or to correct or prevent this variation on the cell level. Also, the library cells with which the process begins are designed without IC layout knowledge, so they are not optimized to result in cell instance uniformity in the finished product.

Although efforts have been made to analyze timing differences added by differences between instances of the same cell in an IC, and to subtract out these differences, this has proven to be difficult to accomplish. It appears that some further step is needed to more tightly predict timing and other performance parameters, so that guard bands can be tightened and IC performance boosted.

### SUMMARY

The present invention includes a method of making instances of a reference cell more uniform across an integrated circuit (IC) by providing a nominal cell for the reference cell and, after an initial Optical Proximal Correction engine run, modifying a subsequent OPC engine run, to force the cell instances to more closely conform to the nominal cell, during an IC layout process.

Other features of the present invention will be apparent from the accompanying drawings and from the detailed description that follows.

### BRIEF DESCRIPTION OF THE DRAWINGS

Exemplary embodiments are illustrated in the drawings. It is intended that the embodiments and figures disclosed herein are to be considered illustrative rather than restrictive.

FIG. 1 is a block diagram of a specific preferred embodiment of the present invention.

FIG. 2A is a block diagram of a generalized preferred embodiment of the present invention.

FIG. 2B is a block diagram detail of block 14 of FIG. 2A.

FIG. 2C is an alternative block diagram of block 14 of FIG. 2A.

FIG. 3A is a graph of a probability ellipse for probable performance resulting from the process of rendering an original layout into a manufactured chip, parametric in power consumption versus delay.

FIG. 3B is a graph of the probability ellipse of FIG. 3A showing an adjusted target for cell performance in the ellipse.

FIG. 4 is a symbolic representation of an integrated circuit (IC) layout, illustrating the use of cells.

FIG. 5 is a symbolic representation of a slightly modified version of the IC layout of FIG. 4, illustrating the effect of optical proximity correction on cells.

FIG. 6 is a symbolic representation of a slightly modified version of the IC layout of FIG. 5, illustrating the process of normalization.

### DETAILED DESCRIPTION OF THE PREFERRED EMBODIMENTS

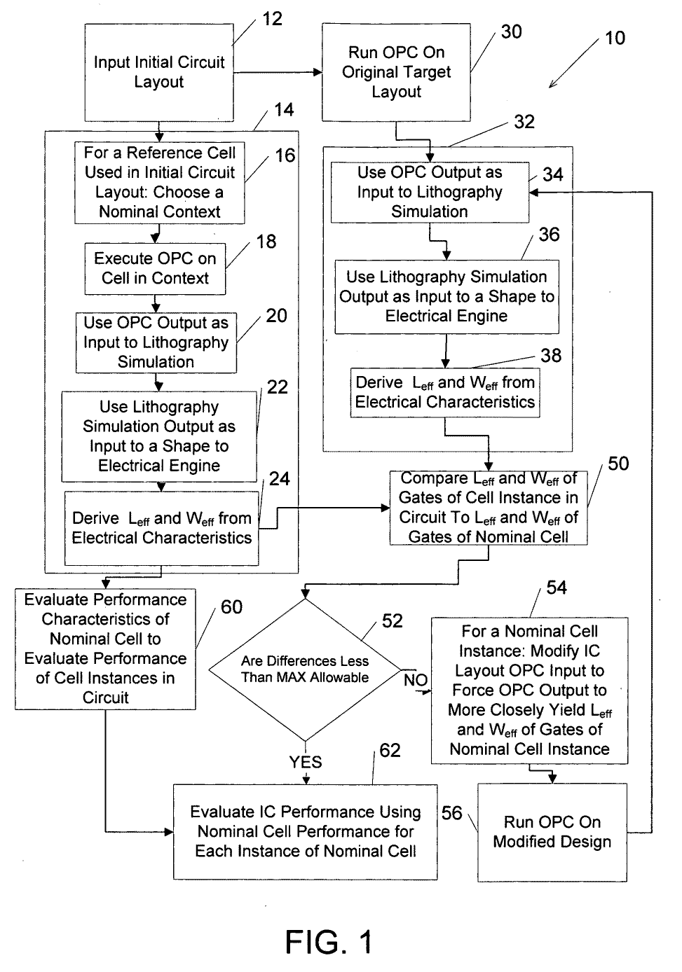

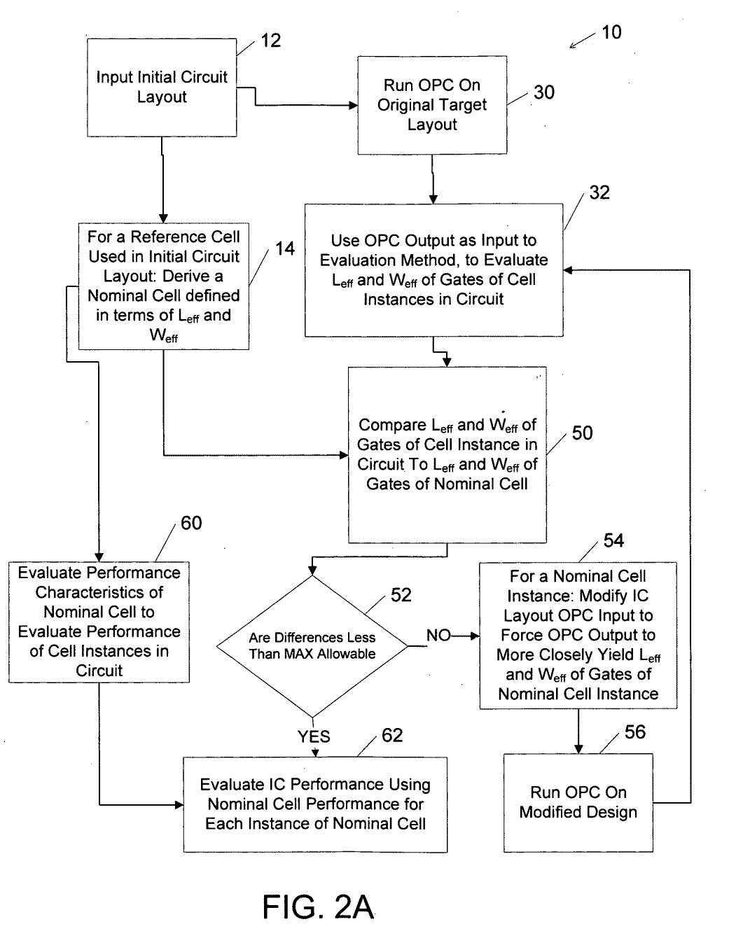

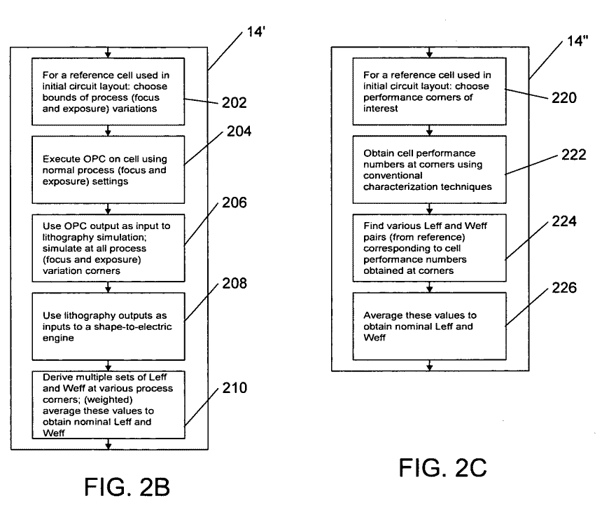

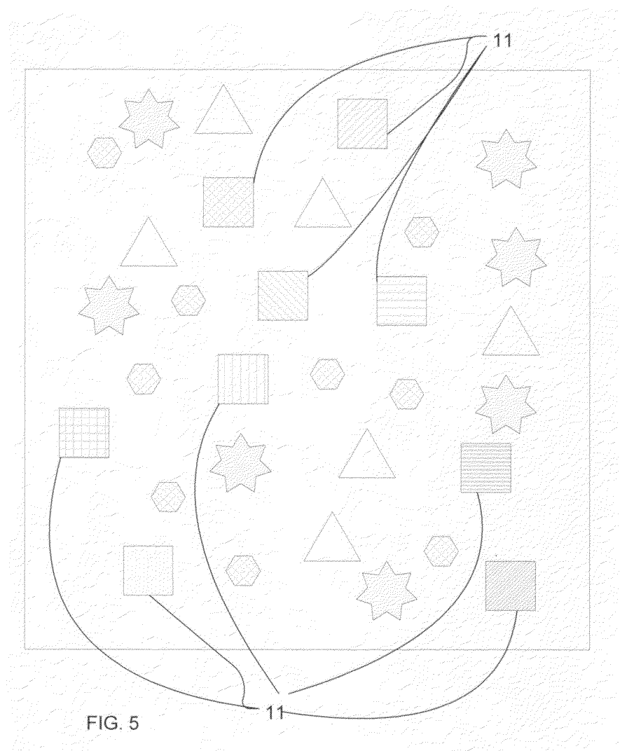

For ease of presentation, a relatively detailed preferred embodiment will be presented first, with reference to FIG. 1, and then a more generalized preferred embodiment will be presented with reference to FIG. 2 Referring to FIG. 1, a preferred embodiment of a method and system 10 according to the present invention begins with a integrated circuit (IC) layout that exists in a computer readable format, typically graphic design system II (“GDSII”). This is read into system 10 by way of software designed to accept and store this information (block 12). It should be noted that a layout of this type is typically divided into “instances” of standard cells, some of which are repeated many times. For example, a NAND gate cell may occur hundreds of times in an IC, and a basic memory block cell could easily be repeated hundreds of thousands of times, in an IC. This is illustrated in FIG. 4, symbolically showing, for several cells, many cell instances, among them cell instances 11, upon which some future discussion will focus.

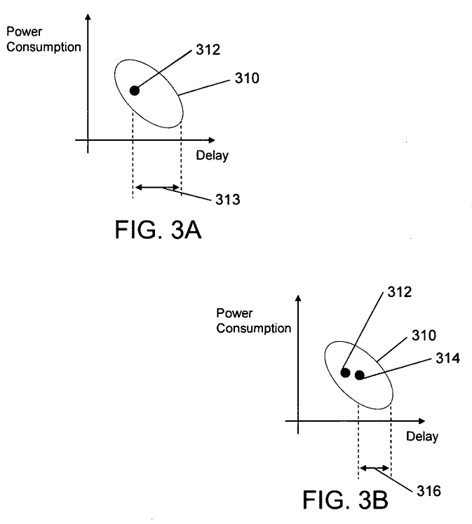

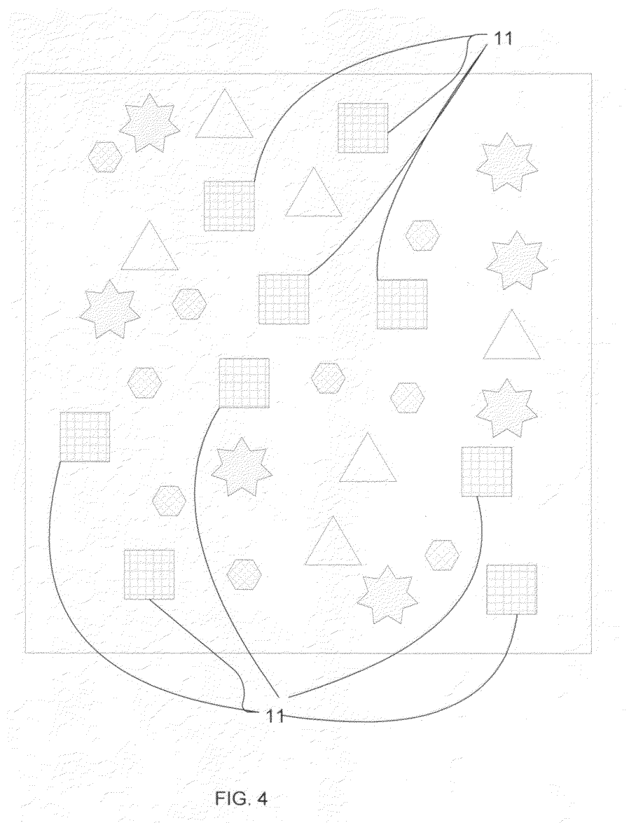

Generalized block 14 represents the derivation of a nominal cell from a reference cell. There are many ways of deriving a nominal cell from its reference cell, based on the expected applications and the performance criteria being used. Generally speaking, a nominal cell is chosen such that it represents an optimized version of its reference cell, that is most likely to yield a properly functioning cell under a probable range of manufacturing process and design context variations. In other words, a nominal cell represents the true “performance center” of a given reference cell under variations. Therefore, using nominal cells in design analysis and optimization allows the designer to full exploit available design margins under variations. This benefit can be observed with the illustrations in FIG. 3A and FIG. 3B (to be described below).

There are three main categories of variations that can be considered in the derivation of nominal cells: (neighboring) context, process variations and measured/characterized performance corners. Below we describe three embodiments of nominal cell derivation considering each of the three variations. Note however that variations considered in nominal cell derivation may not be limited to the above-mentioned categories. Moreover, multiple categories of variations may be considered simultaneously during nominal cell derivation. Lastly, based on whether the design criterion is a worst-case one, a nominal cell may be chosen to represent the worst-case performance (instead of the nominal performance) of a given reference cell under variations.

First, we illustrate how to derive a nominal cell from a reference considering variations introduced via different (neighboring) context surrounding instances of the reference. As noted above, each cell has a set of gates, and in the nominal cell each gate is described in terms of an effective length and width (L_{eff} and W_{eff}). L_{eff} and W_{eff} define a theoretical rectangular gate. The OPC engine will return a masking system adapted to produce gates that approximate an aspect of the electrical performance that would be yielded by the theoretical rectangular gates. In this specific example a context is chosen for the reference cell (block 16), which in this case will be a typical set of circuitry that surrounds the typical cell instance in the IC layout. The cell, together with its context, is input into an OPC engine (block 18), which outputs a descriptor set for a masking system, adapted to fabricate the cell in silicon. Alternatively, a nominal cell can be empirically determined by averaging values of L_{eff} and W_{eff} under all contexts of a set of given representative designs.

This, in turn, may be used as input to a lithography simulation program, which outputs a shape for each gate. This gate shape is typically not a simple rectangle, so L_{eff} and W_{eff} for a particular gate will typically not be immediately apparent from an examination of the lithography simulation output. To find L_{eff} and W_{eff} it is typical to execute a shape-to-electrical simulation, which accepts the cell having the specific gate shapes output by the lithography simulation program and outputs an approximation of the electrical characteristics of the set of gates of the nominal circuit (block 22). The L_{eff} and W_{eff} are then computed, from the electrical characteristics, for each gate of the nominal cell (block 24). A nominal cell has now been derived.

Second, referring to FIG. 2B a nominal cell can be derived from modeling the effects of a set of probable process variations such as photolithography focus and exposure variations (block 14′). In one preferred embodiment , a set of process variations, for example ±100 nm focus variation (from normal focus) and ±5% exposure variation (from normal exposure) is chosen (block 202). The reference cell is input into an OPC engine (block 204) at the normal focus/exposure conditions, which outputs a descriptor set for a masking system, adapted to fabricate the cell in silicon. This descriptor set is, in turn, used as input to a lithography simulation program (block 206), which is executed multiple times, each time modeling a focus and exposure condition set, within the chosen bounds, and including the corners of the bounds. In the above example, the corners of the bounds would constitute a set of four corner condition sets: {(100,5),(−100,5),(100,−5),(−100,−5)}. Each lithography simulation execution outputs a shape for each gate, corresponding to a particular process variation conditions set., for example, 100 nm out-of-focus with 0% exposure variation, or −50 nm out-of-focus with −3% exposure offset . The results will pass through a shape-to-electrical simulation (block 208), which calculates the L_{eff} and W_{eff} values for each process variation condition set. The nominal L_{eff} and W_{eff} can then be computed via weighted average from the values obtained (block 210).

Third, referring to FIG. 2C, a nominal cell can be derived (block 14″) by utilizing gate dimension variation bounds provided by the foundry and typically embedded in the circuit simulation (typically SPICE) used by the designers. In a preferred embodiment, the gate dimension corners of interest are chosen (220) and the simulation is run for these corners (222). The performance numbers yielded by the simulation are then used to derive L_{eff} and W_{eff} at these corners (224). Weighted averages are computed from the various pairs of L_{eff} and W_{eff} yielded to determine L_{eff} and W_{eff} pairs that are central to the corner performance dimensions (226). Note that it is not necessary to invoke lithography simulation, OPC and the shape-to-electric engine in this embodiment.

FIGS. 3A and 3B illustrate an example of the above described method, where the performance metrics used are power consumption versus delay. An ellipse of probable outcomes 310 for efforts to implement a reference cell in silicon are shown, with the reference cell performance given by point 312. A nominal cell is derived having performance given by point 314, which is more likely to actually be produced by the process. The margin needed (by downstream circuitry) to guarantee adequate performance in the event of worst case delay is reduced from margin 313, to margin 315.

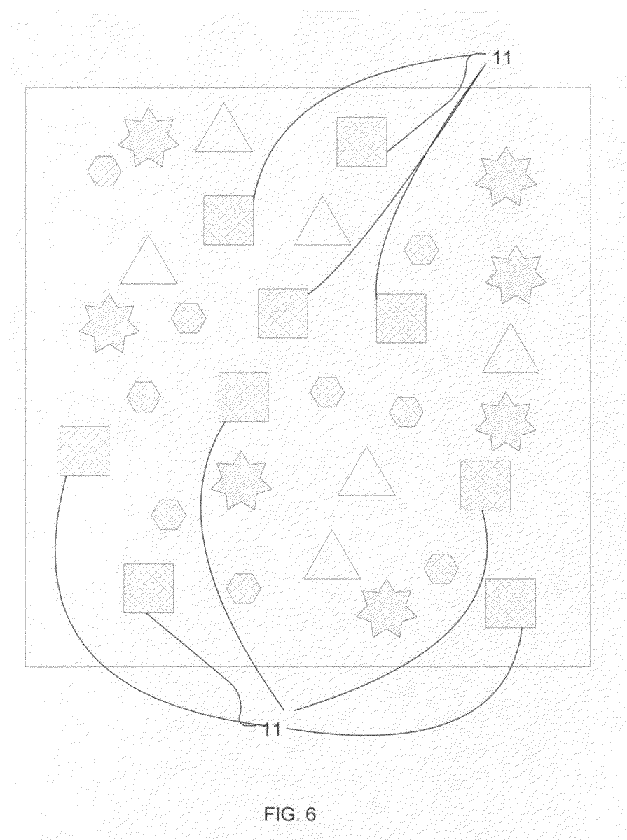

Turning now to the right hand side of FIG. 1, the original target layout, referred to in the first paragraph of this detailed description is used as input to an OPC engine (block 30). The result of this operation, for cell instances 11, is shown symbolically in FIG. 5, where it can be observed that each cell instance has been changed, so that no two are alike. This is not necessarily true for each cell instance, as frequently after OPC at least some of the cell instances, for a particular cell, would be very much alike. But it is intended to make the point that OPC can, and very frequently does, introduce variation from cell instance to cell instance. We may note that one cell instance 11, remains unchanged from its original state. This is also something that could very well happen in the execution of an OPC engine. Cell instances for the other cells will have likely been changed by the OPC engine, also. But these are not the subject of our discussion, so the changes are not illustrated.

Returning to the method of the preferred embodiment, for each cell instance (for the cells corresponding to the nominal cell derived in block 14) an evaluation is performed (block 32) according to an evaluation method that may parallel the method by which the nominal cell was derived. In the detailed case of FIG. 1, a lithography simulation is executed (block 34), yielding a shape for each gate, this is used as an input to a shape-to-electric engine (block 36), which yields electrical characteristics for each gate. The shape-to-electrical engine may take into account geometrical distortion due to lithography and/modulation of stress due to diffusion and poly patterns.

These are used to derive L_{eff} and W_{eff} for each gate (block 38). In the computation of L_{eff} and W_{eff}, L_{eff} may be held constant, or W_{eff} may be held constant, or both may be allowed to vary, depending on the constraints imposed by cell geometry. In some instances, it may be possible to set L_{eff} and W_{eff} to yield identical electrical characteristics, in cases where L_{eff} and W_{eff} of the nominal cell cannot be matched, due to context constraints for the cell instance.

At this point in the process, a nominal cell exists in which each gate is defined in terms of its L_{eff} and W_{eff} and a cell instance from the IC layout has been described in terms, for each gate, of L_{eff} and W_{eff}. Each gate of the cell instance is now compared to each gate of the nominal cell, with the differences being noted (block 50). These differences are compared to a threshold (decision box 52) to determine if the cell instance is close enough to the nominal cell so that the process may be brought to an end. If it is not, the OPC engine is run again, but with some modifications that are designed to force the cell instance (after further simulation or experimental fabrication) to have L_{eff} and W_{eff} values that are closer to those of the nominal cell.

One modification that can be made to the running of the OPC engine is that input for the IC can be manipulated in the region of the cell instance, with the OPC input L_{eff} and W_{eff} for each out-of-tolerance gate being adjusted in a manner intended to yield a closer simulation output L_{eff} and W_{eff} on the next iteration (block 54). These changes can be implemented via annotation layers of the IC layout input to the OPC engine. In another method of modifying an OPC engine run, the lithography model or the OPC recipe that forms a part of the OPC engine can be modified in a manner anticipated to bring about a closer result. Also, the modifications could be encoded into text, fields that accompany the annotation layers of the IC layout description. In another alternative, information embedded in the computer data structure (resident in memory) used by the OPC engine could be modified to effect a modified OPC run. Also, a cell variant could be substituted for the original cell, for one or more instances. Variants may be classified, with a particular variant used in one situation, and another variant used in another. In addition, the layout could be modified by modifying individual cell instances or by modifying a group of cell instances, together.

After the above discussed process has been performed for each cell instance, a modified OPC engine run is performed, and the process is iterated (starting with block 34) until each L_{eff} and W_{eff} is within tolerance. FIG. 6 illustrates the IC layout at the end of the process, with each cell instance 11 now made uniform, but having the characteristics of the nominal cell (symbolized by the diagonal cross-hatching) as opposed to those of the original library cell (symbolized by the vertical and horizontal cross-hatching).

Returning to the nominal cell side of FIG. 1, the mean and variance of the performance characteristics of each nominal cell are determined (block 60). This is discussed in greater detail below. Using these nominal cell performance characteristics permits analysis of the IC design to be performed with the performance of each cell instance defined far more tightly than has generally been possible, heretofore. The tighter definition of cell instance performance permits a reduction in guardband extent, which may permit a tighter, higher performance design.

If the circuit designer knows the performance of a set of cell instances to a finer specificity, he may design the circuit with faster timing than would otherwise be possible. Knowing ahead of time that the cell instances will be forced to match the characteristics of the nominal cell, the circuit designer can design a circuit differently, taking advantage of the more specific knowledge of cell instance performance.

Referring to FIG. 2 and to Tables I, II and III there are many different ways of deriving a nominal cell and of conforming cell instance characteristics to nominal cell characteristics. With respect to block 14, the derivation of the nominal cell, a set of methods for effecting this action is listed in Table I.

TABLE I
Nominal Cell Derivation Methodologies

| Nominal Cell | |
|---|---|
| Derivation | Notes - Possible Evaluation Methods |
| Same as | Same as initial library description of cell |
| Reference | |
| Pick a Context | Context may be 1) average context in IC; 2) worst |
| (Surrounding | case context in IC; 3) isolated context; 4) |
| Circuitry) for | arbitrarily chosen context. |
| Reference Cell | In-Context Fabrication May be Determined by: |
| and Then Derive | 1. OPC -> Partial Production Simulation or |
| Nominal Cell | determination by Experiment |
| Based on | (See Table II) Yields |
| Effects Caused | Electrical Characteristics |
| by Fabrication | -> Electrical to L_{eff} and W_{eff} |
| of Cell | 2. OPC -> Partial Production Simulation |
| Instance in the | Yields Gate Shapes |
| Context of the | -> Shape Abstraction To Yield |
| Chosen | L_{eff} and W_{eff} |
| Surrounding | 3. OPC -> Actual Fabrication -> |
| Circuitry | Measure to find gate shapes and |
| | derive L_{eff} and W_{eff} from gate |
| | shapes |
| Determined by | Input reference cell into computer program which |
| Set of Rules | outputs nominal cell; |
| Arbitrarily or | Definition typically serves to help meet design |
| artificially | goal for a circuit |
| defined | |

The evaluation method of block 32 typically parallels the evaluation method used in the derivation of the nominal cells, choices for which are listed in the second column of Table I. Table II shows level to which IC fabrication is simulated or characterized by experiment, or the effect that is taken into account in the fabricated IC. This level or effect is the level or effect to which cell instances are made uniform.

TABLE II
Production Stage or Effect Taken
Into Account in Derivation of Nominal Cell

| Production stage or effect | |
|---|---|
| taken into account | Notes in explanation |
| Lithography | Simulation or experiment to |
| | the point where the photo |
| | resist has been patterned |
| Etching | Simulation or experiment to the |
| | point where semiconductor has |
| | been patterned, using the photo |
| | resist |
| Chemical Mechanical Polishing | Effects of CMP simulated or |
| (CMP—semiconductor has been | determined by experiment; CMP |
| patterned and CMP has been | takes place before etching |
| performed to smooth top | |
| surface) | |
| Stress | Effect of stress on |
| | electrical properties in |
| | completely fabricated chip |
| Within-die variation | Effect of placement in a |
| | particular position on die in |
| | completely fabricated chip |

With respect to block 60, in a preferred embodiment the performance characteristics for the nominal cell are derived in terms of both mean and variation. Table III describes some methods used to evaluate these quantities. This is a necessary step in achieving the more accurate circuit analysis afforded by the use of nominal cells.

TABLE III
Method of Evaluating Nominal Cell Performance

| Methods of Evaluating Nominal | |
|---|---|
| Cell Performance | Notes |
| Performance (mean and | Many different instances of the |
| variation) of nominal cells may | nominal cell (with the chosen |
| be defined via silicon | context) may be fabricated and |
| measurement | measured, to determine mean and |
| | variation over production |
| | variables. This method is |
| | particularly useful for |
| | quantities that are difficult |
| | to simulate, such as leakage |
| | current |
| Performance (mean and | Simulations may be run under a |
| variation) of nominal cells may | range of assumptions, to |
| be defined via simulations | determine degree to which |
| (such as shape-to-electric) | variation in manufacturing |
| | conditions effects cell |
| | instance performance variation |
| Performance (mean and | Nominal cell may be analyzed |
| variation) of nominal cells may | using a computer program |
| be defined via a set of rules | designed to yield performance |
| | mean and variation |
| Performance (mean and | A design parameter that must be |
| variation) of nominal cells may | met for a cell may be set by |
| be artificially (or | the circuit designer, with |
| arbitrarily) defined | nominal cell and nominal cell |
| | performance flowing from this |
| | choice |

In an alternative preferred embodiment the temperature differences that occur during operation of the IC under a defined set of conditions is taken into account in the computation of L_{eff} and W_{eff} for the cell instance gates. In an additional alternative embodiment, voltage drop across a cell is taken into account in the computation of L_{eff} and W_{eff}.

Neighboring cell instances may be grouped together in practicing the method of a preferred embodiment, to increase efficiency.

In an alternative preferred embodiment more than one nominal reference cell is made for a library reference cell. In some cases it is advantages to use a first nominal reference first cell when a first cell is being fabricated into a first portion of the circuit and a second nominal reference first cell when a first cell is being fabricated into a second portion of the circuit, particularly when it would be impossible or impractical to fabricate the first nominal reference first cell in the second portion of the circuit.

In one preferred embodiment, critical timing paths are first determined by way of a static timing engine. Then, those cell instances that lie along a critical timing path are normalized as described above, to tighten up the timing along the critical paths. In another preferred embodiment, all cell instances are normalized. In yet another preferred embodiment cell instances to be normalized are picked by the circuit designer by way of a heuristic process.

It is a great advantage of the process, that for those cell instances that have been normalized according to this process, timing characteristics can be known to a much greater accuracy than had heretofore been generally possible. Although the normalization of cell instances does not take away every variation from cell performance, it can serve to greatly increase the knowledge of how a cell will perform.

It should be specifically noted that although in the preferred embodiments described in this application, a set of nominal cells, distinct from the library reference cells, are created, this step of creating distinct nominal cells is not an essential part of the process. This is because in an alternative preferred embodiment the library reference cells are used as the nominal cells, without any further derivation.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1) A method of designing and producing an integrated circuit (IC), comprising:
a) providing an initial IC layout, which is divided into instances of reference cells;
b) for at least one reference cell used in said IC layout:
i) providing a description of a nominal cell for said reference cell, said description listing an effective length and effective width (L_{eff} and W_{eff}) for at least some gates of said nominal cell;
ii) inputting said initial IC layout into said OPC engine, thereby producing at least one cell instance OPC output for an instance of said reference cell;
iii) deriving an L_{eff} and W_{eff} for gates of said cell instance OPC output;
iv) comparing said L_{eff} and W_{eff} of said gates of said nominal cell to said L_{eff} and W_{eff} of said gates of said cell instance OPC output;
v) running said OPC engine in a manner that has been modified so as to force said OPC engine to produce said cell instance having gates having L_{eff} and W_{eff} that more closely match the L_{eff} and W_{eff} of the gates of the nominal cell.

2) The method of claim 1, wherein said deriving an L_{eff} and W_{eff} for gates of said cell instance OPC ouput is performed by inputting said IC layout into lithography simulation and then inputting the lithography simulation output into a shape-to-electrical engine and computing said L_{eff} and W_{eff} based on electric characteristics output from said shape-to-electric engine.

3) The method of claim 1, wherein said deriving of an L_{eff} and W_{eff} for gates of said cell instance OPC output is performed by inputting said OPC output for said IC into a lithography simulation and then performing a direct geometric assessment of lithography output.

4) The method of claim 1, wherein said deriving of an L_{eff} and W_{eff} for gates of said cell instance OPC output is performed by inputting said OPC output for said IC into a lithography simulation, the lithography simulation results into an etching simulation, the etching simulation into a shape-to-electrical engine, and deriving L_{eff} and W_{eff} from gate electrical properties output from said shape-to-electrical engine.

5) The method of claim 1, wherein said deriving of an L_{eff} and W_{eff} for gates of said cell instance OPC output is performed by inputting said OPC output for said IC into a lithography simulation, the lithography simulation results into an etching simulation, the etching simulation into a shape-to-electrical engine, modifying the results from the shape to electrical engine by computer modeling of the degree of stress on each gate and deriving L_{eff} and W_{eff} from gate electrical properties that include the effect of stress.

6) The method of claim 1, wherein steps b(ii) through b(v) are performed iteratively until some test is satisfied.

7) The method of claim 6, wherein said test is a test of fidelity of an electrical characteristic to said electrical characteristic of said nominal cell.

8) The method of claim 6, wherein said electrical characteristic is static timing.

9) The method of claim 6, wherein said iterative steps are performed for a single cell instance.

10) The method of claim 6, wherein said iterative steps are performed for a group of cell instances.

11) The method of claim 6, wherein said iterative steps are performed for all instances of a particular cell.

12) The method of claim 1, wherein said step of running said OPC engine in a manner that has been modified includes a resizing of gates of a portion of said IC layout corresponding to said nominal cell.

13) The method of claim 1, wherein said step of running said OPC engine in a manner that has been modified includes changing parameters in a lithography model that is resident in said OPC engine.

14) The method of claim 1, wherein said step of running said OPC engine in a manner that has been modified includes changing data contained in annotation layers of the IC layout that is input to said OPC engine.

15) The method of claim 1, wherein said step of running said OPC engine in a manner that has been modified includes changing fields that accompany the annotation layers of said IC layout description input to said OPC engine.

16) The method of claim 15, wherein said fields that accompany said annotation layers includes text fields.

17) The method of claim 1, wherein said step of running said OPC engine in a manner that has been modified includes modifying said OPC engine.

18) The method of claim 1, wherein an index is generated based on outcome of step (IV).

19) The method of claim 1, wherein said step of running said OPC engine in a manner that has been modified includes inputting a nominal cell variant chosen from a group of variants for said nominal cell.

20) The method of claim 1, wherein said step of providing a nominal cell is performed by deriving a nominal cell from said reference cell.

21) The method of claim 20, wherein said step of deriving a nominal cell is performed in part by choosing a context for said reference cell and performing OPC on said reference cell in its context.

22) The method of claim 20, further including feeding output of said OPC process into a shape-to-electrical engine and computing L_{eff} and W_{eff} from output from said shape-to-electric engine.

23) The method of claim 20, further including computing L_{eff} and W_{eff} directly from an evaluation of gate shapes in said OPC output.

24) The method of claim 20 wherein said step of deriving a nominal cell is performed by applying a set of rules to said reference cell.

25) The method of claim 20 wherein said step of deriving a nominal cell takes into account the effect of stress on electrical characteristics in a finished IC.

26) A method of designing and producing an integrated circuit (IC), comprising:
a) providing an initial IC layout, which is divided into instances of reference cells;
b) for at least one selected reference cell used in said IC layout, deriving a nominal cell having characteristics that improve manufacturability for at least some instances of said reference cell; and
c) substituting said nominal cell for said reference in at least some instances of said selected reference cell, to produce an improved IC layout; and
d) performing optical proximity correction on said improved layout.

27) The method of claim 26, wherein said nominal cell is derived by averaging gate dimensions found at process variation corners.

28) The method of claim 26, wherein said nominal cell is derived by averaging gate dimensions at performance variation corners.
